(19) United States
(12) Patent Application Publication
(10) Pub. No.: US 2016/0184904 A1
(43) Pub. Date: Jun. 30, 2016

(54) DEVICE AND METHOD FOR FORMING A HOLE IN A SURFACE FOR INSERTION OF A TACK INTO THE HOLE

(71) Applicant: TAKKER LTD, Belfast Northern Ireland (GB)

(72) Inventors: Damien McGRANE, Northern Ireland (GB); Eoin LAMBKIN, Northern Ireland (GB)

(21) Appl. No.: 14/892,289

(22) PCT Filed: May 30, 2014
(86) PCT No.: PCT/EP2014/061286

§ 371 Date: Nov. 19, 2015

(30) Foreign Application Priority Data
May 31, 2013 (GB) 1309774.6

(51) Int. Cl. B23B 45/06; B23B 49/00; B23B 51/00; A47G 1/20

(52) U.S. Cl. CPC B23B 45/06; A47G 1/205; B23B 49/00; B23B 51/0054; B23B 2270/34; B23B 2270/48

(57) ABSTRACT

A device and method for forming a hole in the surface for subsequent insertion of a tack into the hole is disclosed. The device including a housing having a base receiving portion, a detachable hole forming rod member held within the housing, a mechanism for turning the hole forming rod member and a mechanism for urging the hole forming rod member out of the housing to form a hole in the surface, wherein the hole is formed substantially perpendicular to the surface. The device further includes a base moveable within the housing and adapted to be retractable into the base receiving portion as the hole forming rod member is urged forwardly to form the hole in the surface.

The present invention relates to a device for forming a hole in a surface for insertion of a tack into the surface so that an object such as a picture, mirror or household object may be hung against the surface and in particular to a hand-held, hand-operated device for forming a hole in a surface such as wood, plasterboard as well as brick and concrete block to facilitate the insertion of a tack into the hole for hanging of an object against the surface.

A number of problems arise when hanging pictures and mirrors on a wall surface. The conventional way of doing this requires drilling a hole (e.g. 6-8 mm wide and 20-30 mm deep) into the wall using a power drill, inserting a plastic or metal anchor (e.g. a rawlplug or other wall plug) into the hole in the wall and subsequently screwing a screw into the plastic or metal anchor. The drill uses masonry or multipurpose drill bits which have been designed to be used with electric power drills. Other methods of hanging pictures and mirrors on a wall involve hammering a nail directly into the wall.

When using conventional methods and devices such as electric power drills, hammers, nails and wall plugs, damage is often caused to the surface, e.g. to the plaster on the wall. The known methods are time consuming and leave the wall with a large hole if the object is moved to another location. Furthermore, more importantly, the drill bit may make contact with electric wires/pipes which may be close to the wall surface. Additionally, many people are reluctant to hang objects on walls because of the need to use electric power drills and associated equipment as they are not comfortable or competent with handling power tools. When using conventional methods, walls with hard surfaces are demanding to work with and difficult to repair if something goes wrong.

It is an object of the present invention to provide a device and method that seek to alleviate the aforementioned problems.

Thus according to a first aspect, the invention provides a device for forming a hole in a surface for subsequent insertion of a tack into the hole, the device comprising:
a housing having a base receiving portion;
means for holding a detachable hole forming rod member;
means for turning the hole forming rod member;
means for urging the hole forming rod member out of the housing to form a hole in the surface, wherein the hole is formed substantially perpendicular to the surface; and
a base moveable within the housing and adapted to be retractable into the base receiving portion as the hole forming rod member is urged forwardly to form the hole in the surface.

The device according to the invention restricts the movement of the hole forming rod member such that the size and shape of the hole is controlled to facilitate the secure insertion of a tack. Any movement of the hole forming rod member other than rotation to create a substantially circular hole is restricted by the device.

Preferably, the base receiving portion is at or towards one end of the housing. The internal profile of the base receiving portion corresponds to the external profile of the top portion of the base.

Preferably, the housing encases each of the means for holding a detachable hole forming rod member, the means for turning the hole forming rod member and the means for urging the hole forming rod member out of the housing.

Preferably, the means for holding a hole forming rod member and the means for urging the hole forming rod member out of the housing co-operate to hold, at all times, the hole forming rod member in a substantially perpendicular orientation relative to the transverse plane of the base receiving portion of the housing.

Preferably, the device includes one or more levelling and/or measurement devices to facilitate the hole being formed substantially parallel to the ground and/or perpendicular to the surface. The levelling device may be a spirit level, e.g. a spirit level in the housing, a laser levelling device or the like. The measurement device is preferably a ruler embossed on the base or a laser measurement device incorporated in the housing.

Preferably, the base is configured to be moveable laterally with respect to the housing of the device.

Preferably, the device is adapted to ensure that, in use, a hole forming rod member protrudes from the device on compression of base. This enables a worn hole forming rod member to be easily removed from the device for replacement purposes.

In a preferred embodiment, in use, a hole forming rod member protrudes from a locating hole in the base. That is, when the device is placed with its base against a surface into which the hole is to be formed and the means for turning the hole forming rod member is turned, the hole forming rod member is urged through a locating hole in the base. The locating hole is preferably located in the centre of the base. The base preferably further comprises a detachable dust collector which fits into the locating hole. The dust collector has a hole in the middle from which the hole forming rod member protrudes in use. That is, the dust collector surrounds the locating hole and a detachable cap fits into dust collector, the dust collector cap having a hole in the middle from which the hole forming rod member protrudes in use.

Preferably, the means for holding a hole forming rod member is located generally in or towards the centre of the device. This has the advantage that a user can be left or right handed and will not have to adapt the manner in which they use the device.

In use, a detachable hole forming rod member is located in the means for holding the detachable hole forming rod member. The hole forming rod member is configured to penetrate the surface and to be urged forwardly so as to form the hole in the surface without causing damage to the surrounding surface. A tack may then be inserted into the hole formed in the surface.

Advantageously, a first hole forming rod member suitable for forming a hole in a first surface can be inserted into the means for holding the hole forming member; and this first hole forming rod member can be substituted by a different hole forming rod member suitable for forming a hole in a different surface such that a variety of suitable hole forming rod members can be inserted in the device, depending on the surface in which the hole is to be formed. Alternatively, the hole forming rod member can be adapted to form a hole in multiple types of surfaces, i.e. the hole forming rod member can be a multipurpose hole forming rod member, so that a single rod member may be used to form a hole in a variety of different surfaces.

Preferably, the hole forming rod member comprises an elongate member adapted at one end to engage with the means for turning the rod member and adapted at the other end to penetrate a surface and form an elongate hole in the surface. Conveniently, a tack may be inserted into the hole and an object may be hung from the tack inserted in the hole.

In a preferred embodiment, the device comprises a storage section which is adapted to store alternative types of hole forming rod members for coping with a variety of surface types, e.g. glass, wood, concrete block. Preferably, the storage section is in the housing of the device.

Preferably, the surface in which the hole is formed is a surface made of any construction material such as concrete (e.g. high ratio concrete plaster mix or concrete building block), glass, tile, ceramic, wood, plasterboard, brick, stone, cinderblock or the like, e.g. a concrete wall surface.

The use of the device is not limited to facilitating the insertion of a tack into a wall. Other suitable surfaces include dado rails, cupboards and so on. Preferably, the device is hand-operated. Particularly preferably, the device is solely operated by hand. Alternatively, the device is motorised and battery operated.

When the device is operated by way of a battery and motor arrangement, the device preferably comprises a winding handle and the battery is charged via rotation of the winding handle.

The device of the present invention can be used to form a hole in a surface where the surface is a wall surface constructed of high ratio concrete plaster mix, concrete building block, brick or the like, e.g. the internal or external wall of a building.

The base is adapted to retract into the base receiving portion. The base is moveable between a fully extended position and a fully retracted position. Preferably, the base retracts by way of up and down movement. Furthermore, the base is adapted to be moveable with respect to the housing of the device.

The base is adapted to be both evenly and unevenly retractable into the base receiving portion, i.e. each end of the base is adapted to retract into the housing independently, e.g. one end is adapted to be retractable to a larger or lesser extent than the other end. The ability of the base to move relative to the housing in this way eliminates the likelihood of “stiction”, i.e. avoids the static friction that needs to be overcome when forming a hole in a surface.

In a preferred embodiment, the base is adapted to move in any direction with respect to the housing, particularly preferably from left to right and/or forwards and backwards with respect to the housing in addition to up and down. Preferably, the base is adapted to move up to approximately 3 mm from left to right and/or forwards and backwards with respect to the housing, i.e. in the range of from about 1 mm to about 3 mm. The ability of the base to move relative to the housing in this way eliminates the likelihood of “stiction”, i.e. avoids the static friction that needs to be overcome when forming a hole in a surface.

Preferably, the base is adapted to pivot with respect to the housing. Particularly preferably, the pivoting movement of the base with respect to the housing of the device is about 2 degrees.

Preferably, the base comprises a cross portion for added stability, optionally wherein the cross portion is detachable. This cross portion is a stabilising member which is preferably moveable, e.g. pivotable, from a position substantially perpendicular with respect to the base, i.e. a position which results in the footprint of the device being a cross, or otherwise angled with respect to the base to a position in which it is not angled with respect to the base, i.e. to a position in which the cross portion is hidden when the device is viewed from above. Preferably, the cross portion comprises one or more pivotable feet.

Preferably, resilient means in the device facilitate the retraction and compression of the base into the base receiving portion of the housing. The resilient means comprises biasing means, e.g. a spring. The base is preferably secured to the device by at least one post moveably located in a guide sleeve adapted to receive the at least one post. The resilient means, the at least one guide sleeve and the at least post are preferably encased within the housing. The resilient means are preferably provided on the posts. Preferably, the post comprises a shoulder on which the resilient means rests. Ideally, there are two posts and two respective guide sleeves, i.e. each guide sleeve is adapted to receive one post.

Preferably, the base comprises one of said post and guide sleeve, the post or guide sleeve preferably upstanding from the base, and the base receiving portion comprises the other of said post and guide sleeve.

Preferably, at least one guide sleeve and at least one post are located towards one end of the device and at least one guide sleeve and at least one post are located towards an opposing end of the device.

Particularly preferably, the means for holding the hole forming rod member is located in between at least two guide sleeves such that the guide sleeves are each equally distanced from the means for holding the hole forming rod member.

In use, this position of the guide sleeves with respect to the hole forming rod member advantageously ensures that the hole forming rod member rotates as smoothly as possible and facilitates the stable operation of the base and hole forming rod member.

In a most preferred embodiment, in order to increase stability during operation, the means for holding the hole forming rod member is located generally in or towards the centre of the device and the guide sleeves are located at equal distances from the means for holding the hole forming rod member.

The profile of the guide sleeves corresponds substantially to the profile of the posts. The posts may be cylindrical, rectangular, of an oval cross section or of any other suitable shape, e.g. having a T-shape or X-shape cross section. Resilient means, e.g. springs, may be provided on the posts. On compression of the base, forces travel between the posts. Preferably, the top of the posts are provided with a section of smaller cross section and it is on this section that the resilient means are conveniently provided. In this embodiment, the larger cross-section of the post provides a shoulder on which the resilient means rests.

The base preferably comprises at least one post for engagement with the base receiving portion of the housing, particularly preferably 2 or 4 posts. However, any number of posts may be present.

The base receiving portion preferably comprises at least one guide sleeve for receiving a post. Particularly preferably, each post has a respective guide sleeve. The guide sleeve is preferably larger than the post so as to provide the base with movement with respect to the housing in a direction other than up and down, e.g. with movement in a lateral direction. Particularly preferably, the width of the guide sleeve is in the range of from approximately 0.05 mm to approximately 0.25 mm larger than the width of the post, i.e. approximately 0.15 mm wider. This results in the clearance of the posts being in the range of approximately 0.1 mm to approximately 0.5 mm, e.g. approximately 0.3 mm.

Alternatively, rather than the base comprising a post and the base receiving portion comprising a guide sleeve, the base comprises a guide sleeve and the base receiving portion comprises a post. In this embodiment, resilient means, e.g. a spring, are preferably provided in the base receiving portion, e.g. around a post, to enable the base to have movement with respect to the housing in the direction of the longitudinal axis of the post, i.e. up and down. As above, the posts may have a section with a smaller cross section than the remainder of the post and it is here, on the portion with a smaller cross section, that the resilient means are preferably provided.

In a preferred embodiment, the angle of the base with respect to the housing is fixed to compensate for a non-perpendicular wall, especially a wall that leans inwards, so that the hole is parallel to the ground rather than perpendicular to the wall. This ensures that an inserted tack remains in the hole and an object hung on the tack is secure. Alternatively and preferably, the angle of the base with respect to the housing may be set by the user. In this embodiment, the angled base is pivotable with respect to the device.

Preferably, the device is configured to form a hole in uneven surfaces. In this embodiment, the base contacts the wall at three or more fixed points rather than being totally flush with the surface in which the hole is to be formed. In this embodiment, the base comprises feet which contact the surface in which the hole is to be formed. The remainder of the base does not contact the surface. The feet are preferably spherical. However, the feet may have any suitable shape which serves to distance the remainder of the base from the surface in which the hole is to be formed.

Preferably, the device is a hand-held device, particularly preferably a hand-held device comprising a handle. Preferably, the handle is configured such that the user's hand is directly above the hole forming rod member. Particularly preferably, the handle is configured such that the device can be held in the optimum orientation for forming a hole. The handle is preferably arcuate and indented to receive a user's left or right hand.

In a preferred embodiment, the device comprises a storage section which is adapted to store tacks for insertion into the hole formed by the device in a surface. Preferably, the storage section is in the handle of the device. Preferably, the storage section is pivotably attached to the device.

Preferably, the device is made from plastics material and may be formed by moulding.

In a preferred embodiment, the hole formed by the device has a diameter in the range of from 1.0 mm up to approximately 6.0 mm, preferably a diameter in the range of from about 2.0 mm up to approximately 4.5 mm, e.g. approximately 3.0 mm. The diameter of the hole is substantially equivalent to the diameter of the detachable hole-forming rod member. This is due to the fact that any movement of the hole forming rod member other than rotation to create a hole is restricted by the device. However, due to the movability of the base, i.e. the float, the hole can deviate from having a circular diameter, i.e. the hole formed by the device is slightly eccentric in shape, and is preferably ellipsoidal. In this embodiment, both the major and minor axes of the hole formed by the device are in the range of from 1.0 mm up to approximately 6.0 mm, preferably in the range of from about 2.0 mm up to approximately 4.5 mm, e.g. approximately 3.0 mm.

The hole formed by the device is shallow to reduce the chances of damaging electric cables or pipes. In a preferred embodiment, the hole formed by the device is up to 20 mm deep, preferably in the range of from about 8.0 mm to about 16.0 mm, e.g. approximately 12 mm. The depth of the hole is substantially equivalent to the amount the base compresses against the housing of the device whilst the hole is being formed.

The advantage of the hole being perpendicular to the surface is that the tack is more secure than if the hole were at any other angle, i.e. the tack is less likely to fall out of the hole. Additionally, the tack can bear heavier loads when it is inserted into a hole which is substantially perpendicular to the surface.

Preferably, the hole is of about 10 mm depth and about 3 mm diameter at a 90 degree angle to the surface.

In a preferred embodiment, the means for turning the hole forming rod member is located generally in or towards the centre of the device.

In one embodiment, the means for turning the hole forming rod member against the surface to penetrate the surface comprises a winding mechanism and associated gearing mechanism. The hole forming rod member breaks the surface with the first turn of the winding mechanism.

Preferably, the winding mechanism comprises a hand-operated winding mechanism, e.g. a winding handle. Preferably, in use, the winding mechanism is turned at a speed of 60-300 rpm. This is a relatively slow speed which is achievable by hand-operation of the winding mechanism.

Preferably, the hole forming rod member is turned slowly, i.e. turned at a speed of up to 30 revolutions per 1 turn of the winding mechanism, particularly preferably at a speed of from 1 to 20 revolutions per 1 turn of the winding mechanism, e.g. 4 revolutions per turn of the handle. The hole forming rod member is especially preferably turned at a speed of from 5 to 10 revolutions per 1 turn of the winding mechanism. Turning with this slow speed causes less damage to the surface than would be caused using a power drill.

In the embodiment wherein the device is operated by way of a battery and motor arrangement, the charged battery supplies current to the motor causing the hole forming rod member to rotate at an appropriate speed as described herein, preferably wherein the speed is set by the user. The advantage of having a battery powered device is that the user can hold the unit with both hands whilst the hole is being formed rather than holding the device in one hand and turning a winding mechanism with the other hand.

In a preferred embodiment, the number of revolutions of the hole forming rod member may be altered depending on the surface in which the hole is to be formed. Preferably, this is achieved by with an automated cut-off of the device which stops the hole forming rod member once the required depth is met. Preferably, the device comprises a counter with means for stopping the rotation of the hole forming rod member after a predetermined number of turns. Other safety devices may be included to ensure the hole forming rod member can only be rotated when it touches a surface.

Preferably, the gearing mechanism comprises bevel gears. Bevel gears or the like may be used to change the direction of rotation, i.e. if the winding mechanism is turned in a vertical direction, the hole forming rod member will rotate in a horizontal direction, i.e. the axes of the shaft of the bevel gears intersect, preferably at 90°.

Bevel gears or the like may be used to increase speed of rotation of the hole forming rod member. In a preferred embodiment, the ratio of the amount of teeth in the faces of the bevel gears is up to 1:30, preferably from 1:20 to 1:5, the drive gear having the higher number of teeth and the driven gear the lower number. In a particularly preferred embodiment, one turn of the winding mechanism results in four turns of the hole forming rod member.

Preferably, the hole forming rod member is turned at a speed in the range of from approximately 1 to 300 revolutions per minute, particularly preferably 150 to 250 revolutions per minute, e.g. 240 revolutions per minute. Turning with this slow speed causes less damage to the surface than would be caused using a power drill.

In a preferred embodiment, the base retracts into the device by predetermined amount, e.g. by approximately 1 mm to 15 mm, e.g. 3 mm. Particularly preferably, the base retracts substantially evenly into the device.

Preferably, the housing is provided with flanges at or towards the end of the housing having the base receiving portion. Preferably, the base is provided with corresponding flanges. Such flanges on the housing and/or the base provide extra stability to the device when it is placed against a wall.

In a preferred embodiment, the device further comprises means for inserting a tack into the hole in the surface. The means for inserting a tack into a hole in a surface may take any suitable form. In a preferred embodiment, the means for inserting a tack comprises a protruding member which fits over the head of the tack, preferably fitting over the whole head of the tack and alternatively only fitting over a portion of the head of the tack, thus enabling the device to be used in a hammer-like fashion. In an alternative preferred embodiment, the means for inserting a tack comprises a plunger and resilient means. When the user pulls back the plunger, a tack is loaded. When the plunger is released, the tack is released from the device and inserted into the hole. Preferably the tack is in a form as described herein below.

In a preferred embodiment, the device according to the invention further comprises means for removing a tack from a hole in the surface. Preferably, the means for removing a tack is located on the outside of the device between the handle and the base receiving portion. The means for removing a tack may be a protruding member, preferably a U-shaped protruding member, having an internal profile corresponding to the shape of the head of a tack, preferably the shape of a tack as described herein below.

In another embodiment, the device according to the invention is adapted to be attached to a known device for inserting a tack into a wall. The device according to the invention may be attached to the side or base of the known device. The device in this embodiment of the invention preferably comprises retaining means to secure the known device.

In another aspect, the invention provides a tack for insertion into a hole formed in the surface so as to enable the hanging of objects of up to 10 kg in weight, preferably objects up to 15 kg in weight. The tack comprises an elongate, preferably cylindrical, body, a head and collar, wherein the body comprises a wider elongate section and a narrower elongate section, wherein the head is at the end of the narrower section and the collar is mounted intermediate the sections, wherein the head and collar have a diameter wider than the diameter of the body and wherein, in use an object may be hung from the tack. Preferably, the distance between the collar and the head is equal to a third of the length of the tack.

The length of the tack is preferably in the range of from 8.0 mm to about 24.0 mm, preferably 12.0 mm to 16.0 mm, e.g. approximately 14 mm. The diameter of the collar of the tack is preferably 2 mm to 4 mm, e.g. 3 mm. The diameter of the head of the tack is preferably preferably 3 mm to 6 mm, e.g. 4 mm.

The tack is adapted to be able to carry a weight of up to approximately 10 kg, preferably a weight of up to approximately 1.0 g to approximately 10.0 kg. The tack is adapted to securely fit into a hole that may be oval due to a small amount of movement of the hole forming rod member as the hole is formed. The tacks are designed to work with a hole that is eccentric in shape, i.e. a hole, the area of which deviates from a perfect circle. The tacks also work with circular holes.

Preferably, the tack comprises plastic. Particularly preferably, the head of the tack is made of plastic.

In a preferred embodiment, the elongate body, preferably the wider elongate section, of the tack is provided with ribs which distort to the shape of the hole in the surface, e.g. a wall in which the hole is formed using the device of the present invention. This distortion of the ribs to the shape of the hole in the surface has the advantage that the tack is held more securely in the hole in the wall formed by the device. Preferably, the elongate body of the tack has a substantially cruciform shape which adapts to the shape of the hole when inserted.

In another aspect, the invention provides a method for inserting a tack into a surface using the device as described herein. The method of forming a hole and inserting a tack using the device of the invention requires no other tools and takes less than 90 seconds to complete, preferably less than 30 seconds.

The method according to the invention preferably comprises the following steps:
a) placing the device against the surface in which the hole is to be formed;
b) rotating the means for turning the hole forming rod member causing the hole forming rod member to penetrate the surface; and
c) further rotating the means for turning the hole forming rod member until the base is retracted and compressed into the base receiving end portion of the device.

The method according to the invention conveniently further comprises the following step:
d) inserting a tack into the surface, e.g. using the means for inserting a tack as described above, preferably wherein the tack is a tack as described herein.

Preferably, the method comprises the following steps:
i) A hole forming rod member is pushed through a locating hole in the base of the device and pushed up until it clicks into a locking slot of a drive spindle to fix the hole forming rod member in place.
ii) The device is then placed against a surface, e.g. a wall. Advantageously, the device may be held in one hand.
iii) The winding handle is then rotated, e.g. clockwise or counter clockwise, causing the hole forming gear mechanism to turn the hole forming rod member against the wall surface which breaks the wall surface.
iv) As the hole forming rod member penetrates the wall surface on further turning of the handle, the base depresses against the springs inside the housing of the device. Due to the structure of the base and base receiving portion, the device is maintained positioned in a perpendicular axis.
v) The winding handle is rotated until the base is compressed against the housing of the device, for example, in the embodiment where the base and housing are provided with complementary flanges, until the flange of the base abuts the flange of housing. This indicates that the hole forming rod member has travelled the depth of the base, e.g. 12 mm, to complete the depth of hole required.
vi) A tack is then fully inserted into the hole in the wall surface, optionally using the means for inserting a tack from the device, e.g. a protrusion on the outside of the housing of the device.

The invention will now be described with reference to the accompanying drawings which show a variety of preferred embodiments of the device in accordance with the invention in which:—

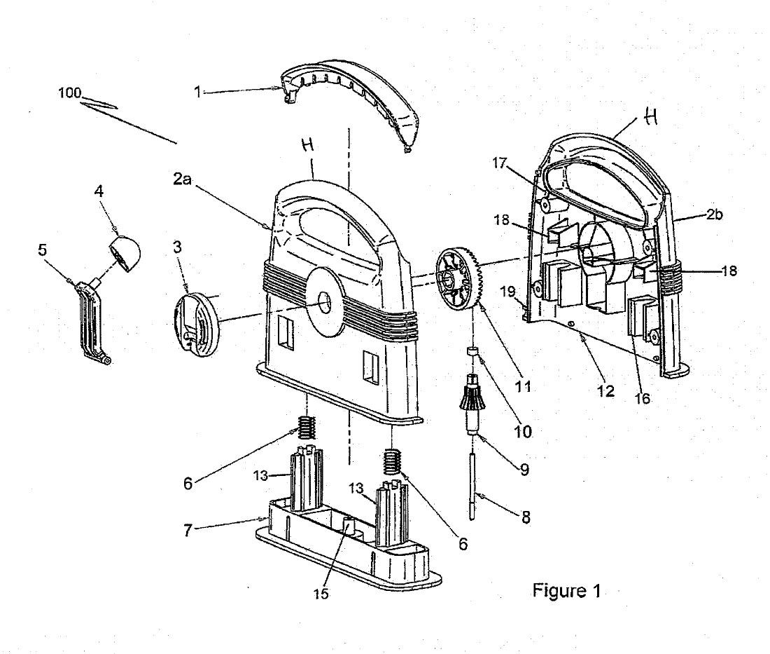

FIG. 1 is an exploded view of the device according to the invention;

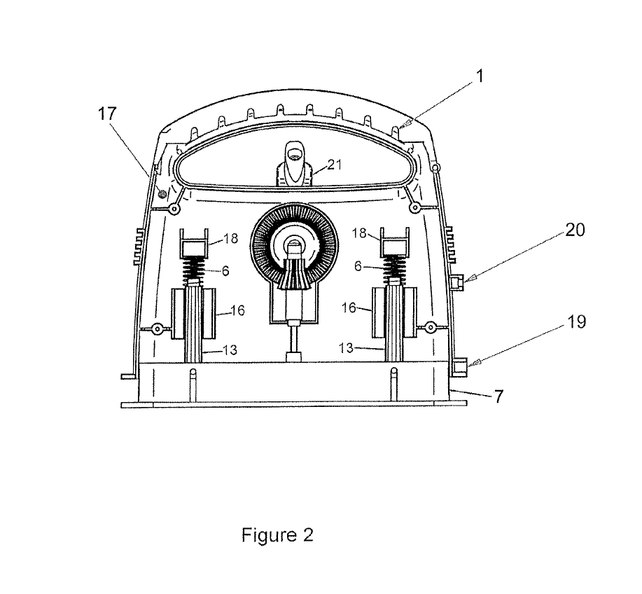

FIG. 2 is a front view of the device according to the invention with one side of the housing removed;

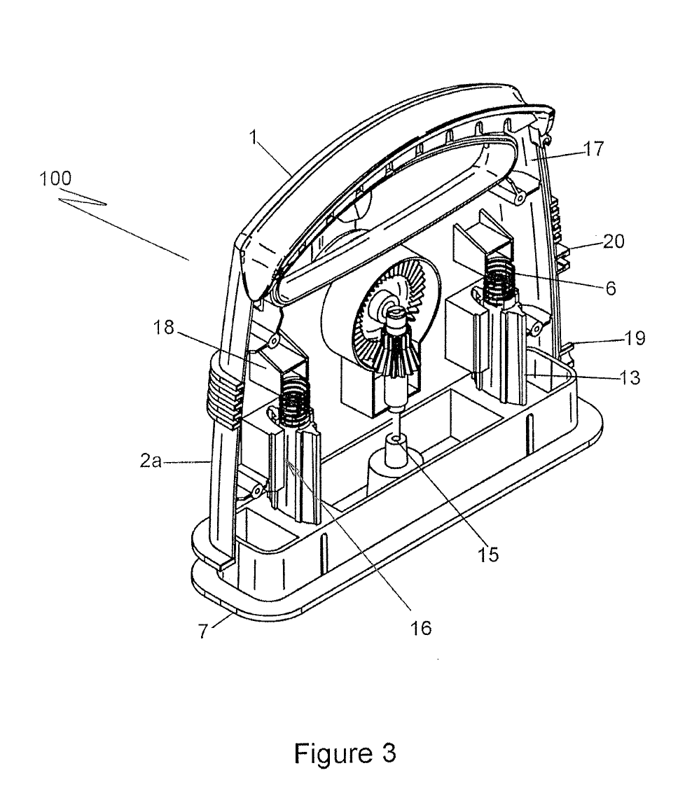

FIG. 3 is a perspective view of the device according to the invention with one side of the housing removed;

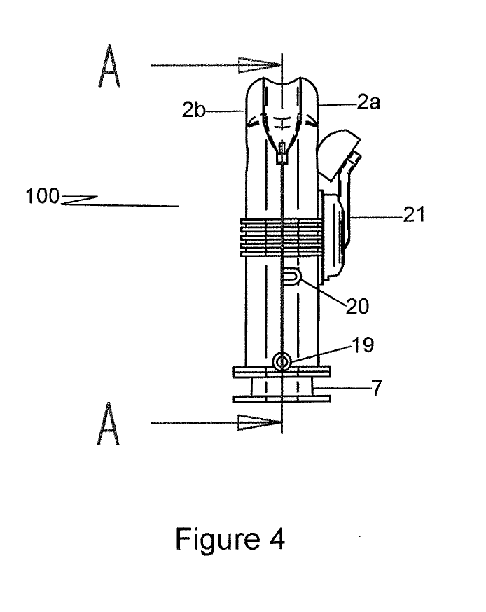

FIG. 4 is a side view of the device according to the invention;

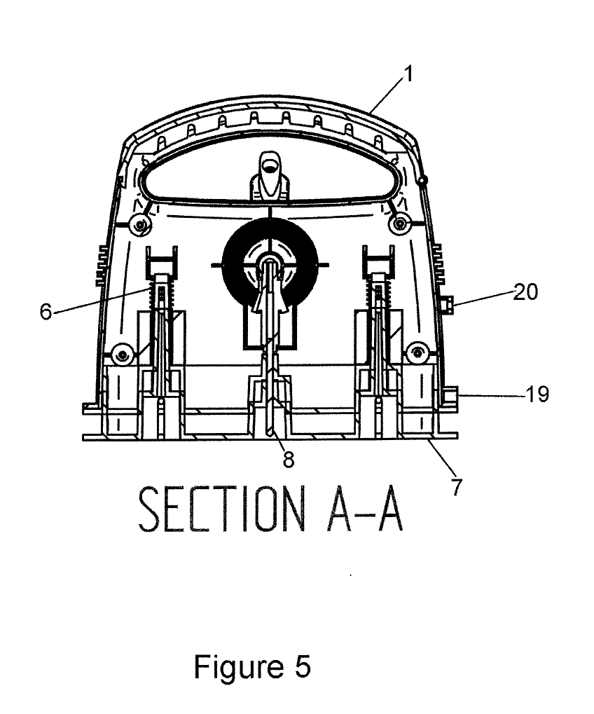

FIG. 5 is a sectional view along the line A-A in FIG. 4;

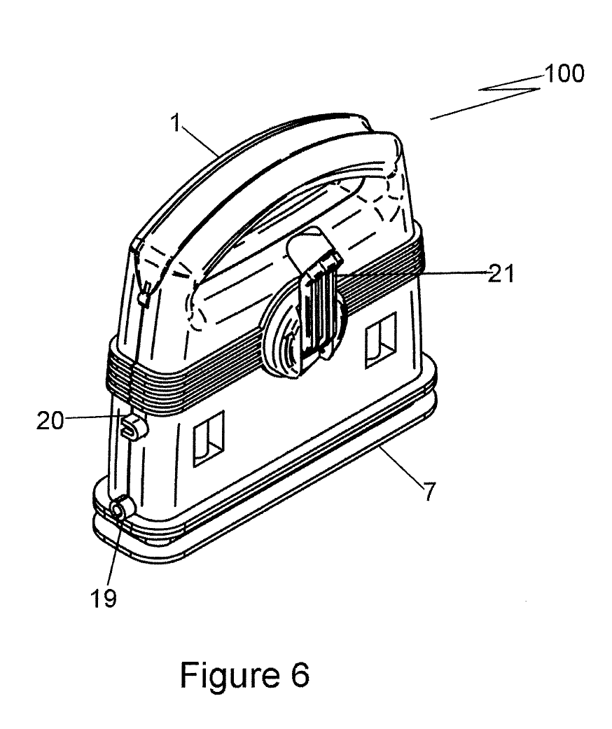

FIG. 6 is a perspective view of the device according to the invention;

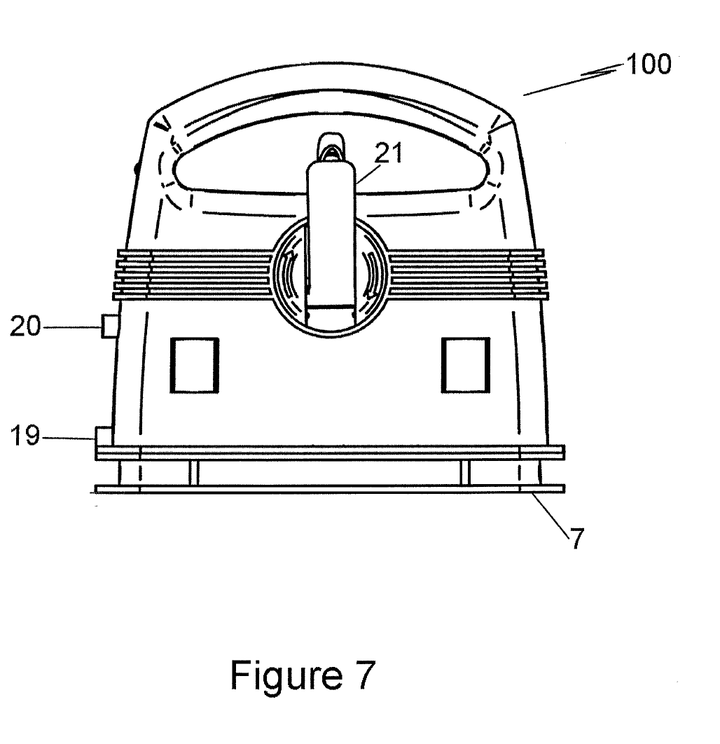

FIG. 7 is a front view of the device of FIG. 1;

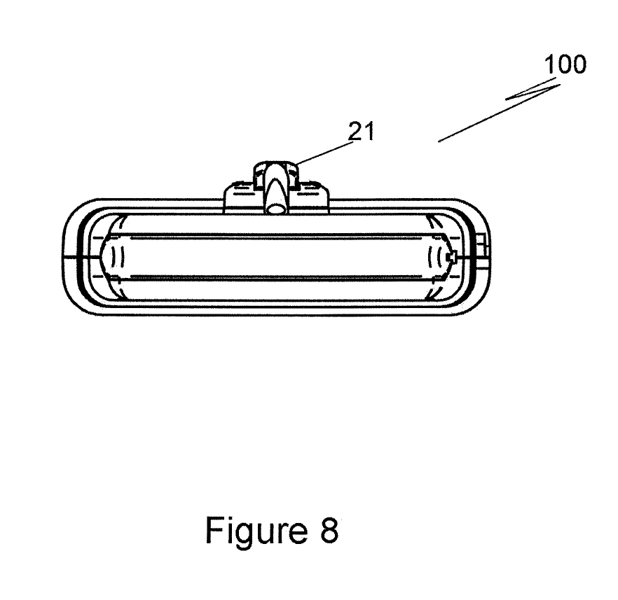

FIG. 8 is a plan view of the device according to the invention;

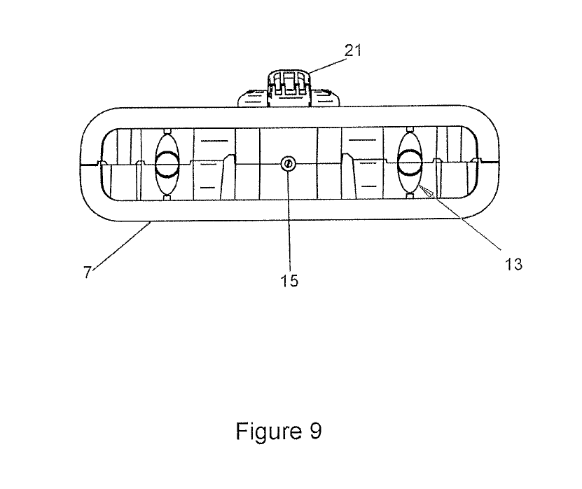

FIG. 9 is a plan view from below of the device according to the invention;

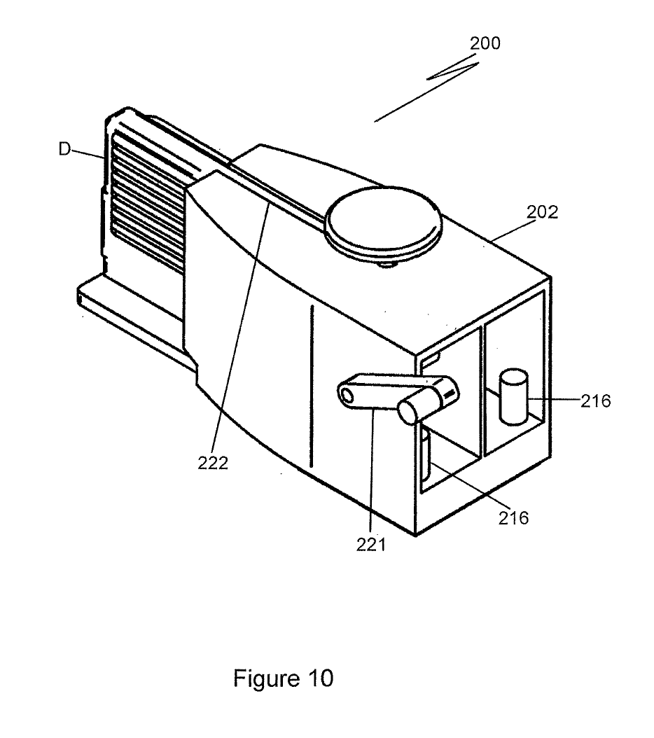

FIG. 10 is a perspective view an alternative device according to the invention;

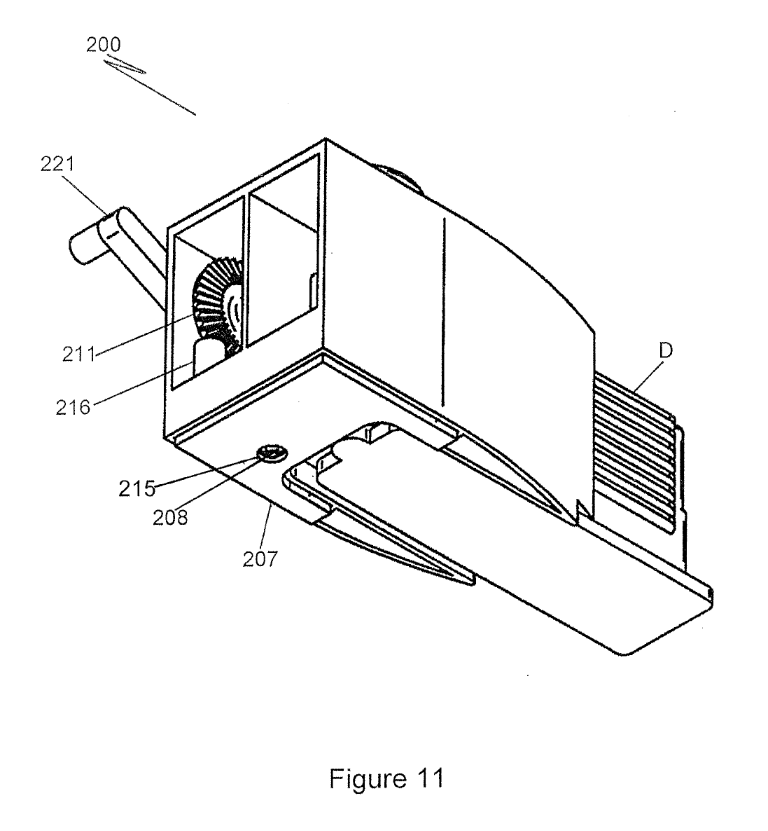

FIG. 11 is a perspective view from below of the device of FIG. 10 showing the base which is adapted to compress against the housing of the device;

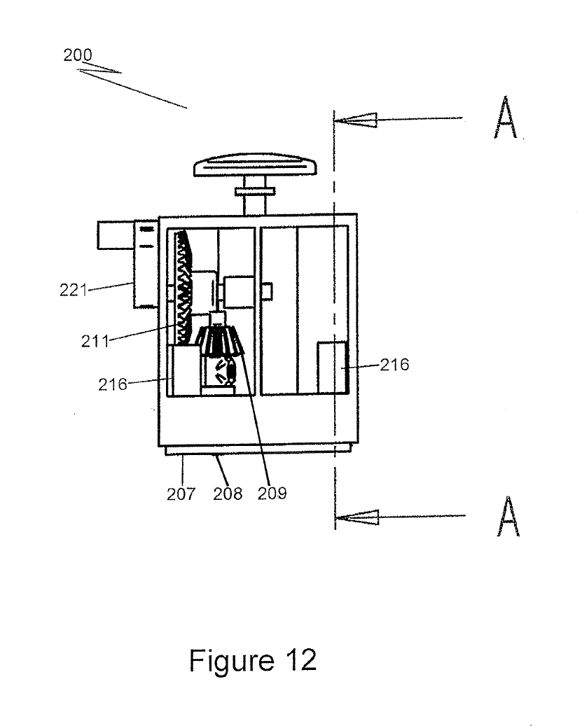

FIG. 12 is a front view of the device of FIG. 10;

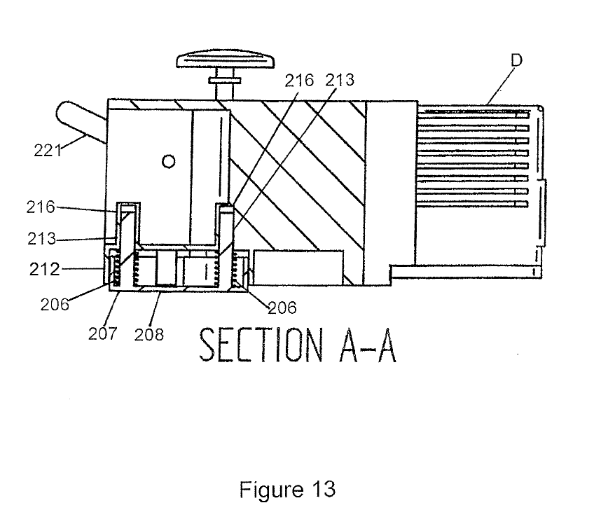

FIG. 13 is a sectional view along the line A-A in FIG. 12;

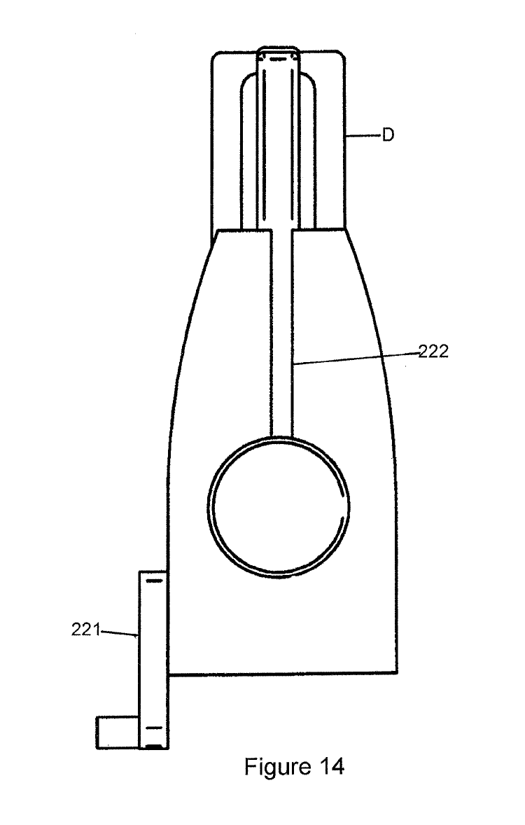

FIG. 14 is a plan view of the device of FIG. 10;

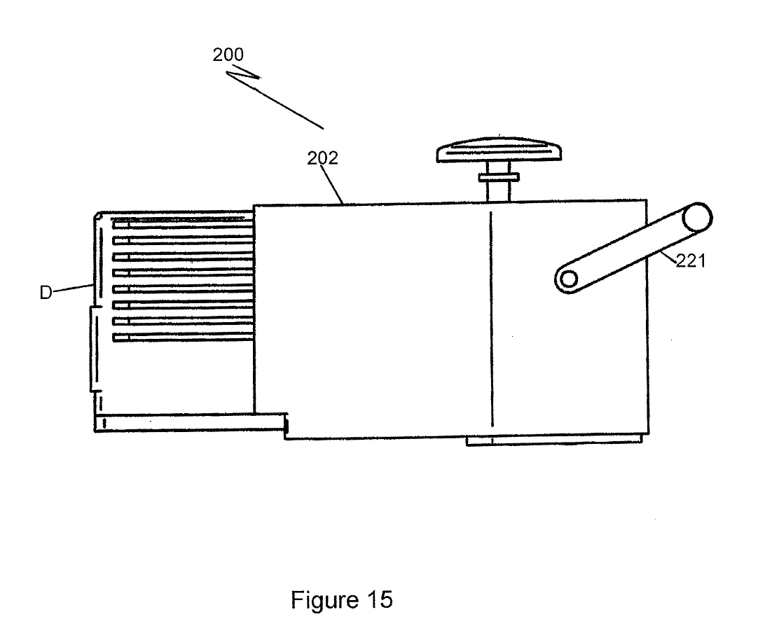

FIG. 15 is a side view of the device of FIG. 10;

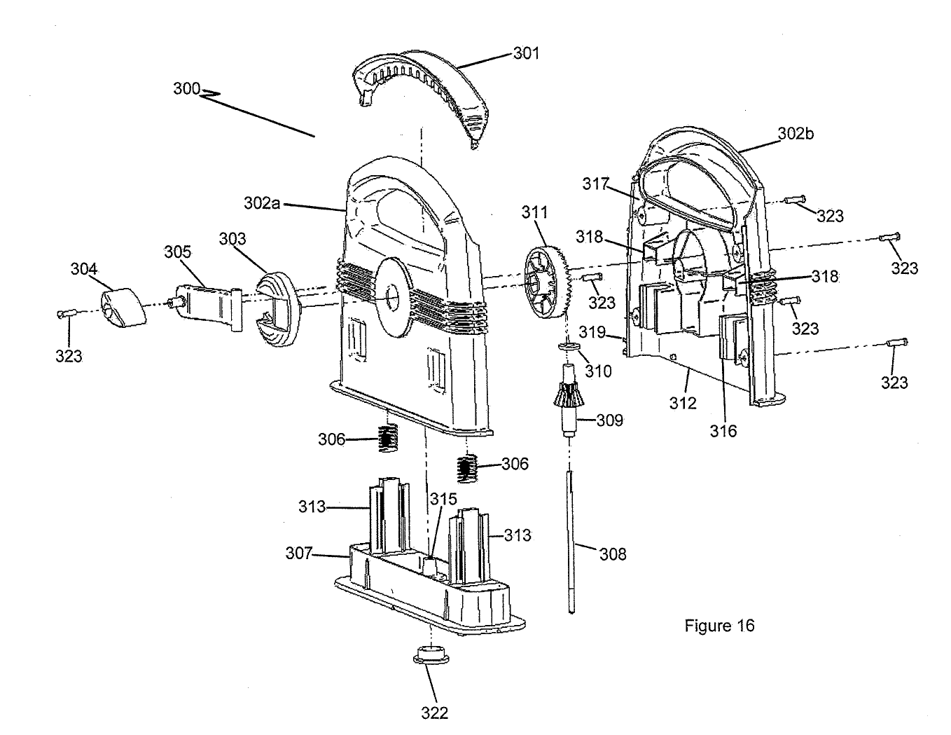

FIG. 16 is an exploded view of a preferred device according to the invention;

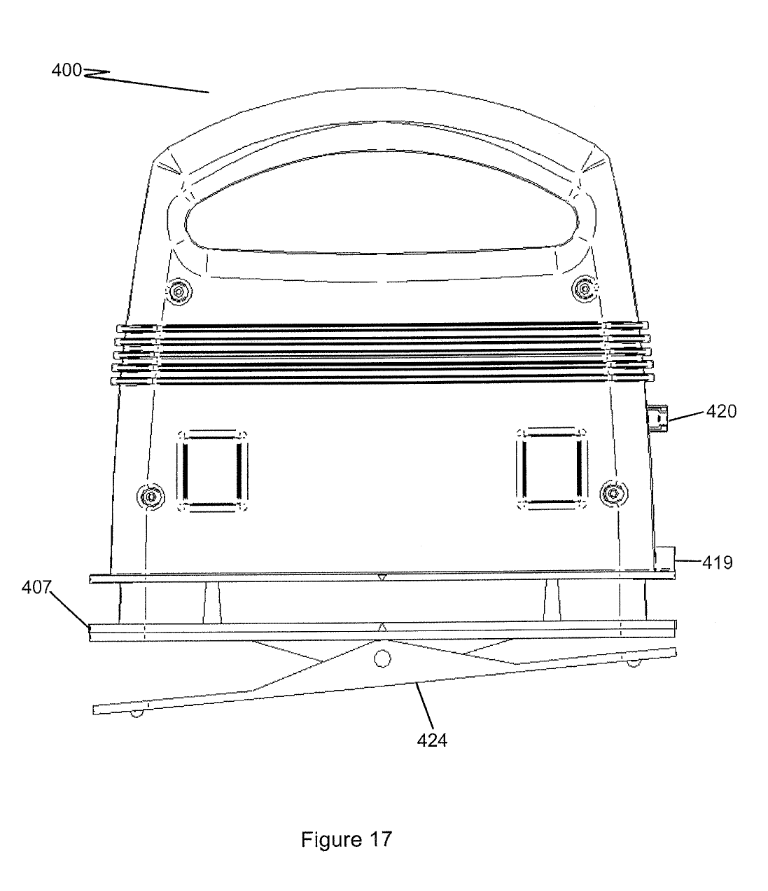

FIG. 17 is a front view of a device with an angled base;

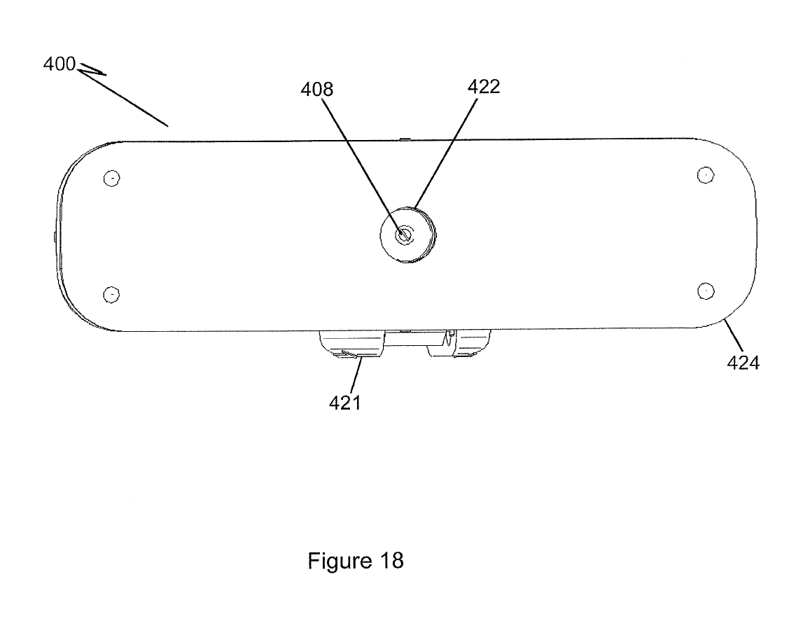

FIG. 18 is a view from below of the device of FIG. 17;

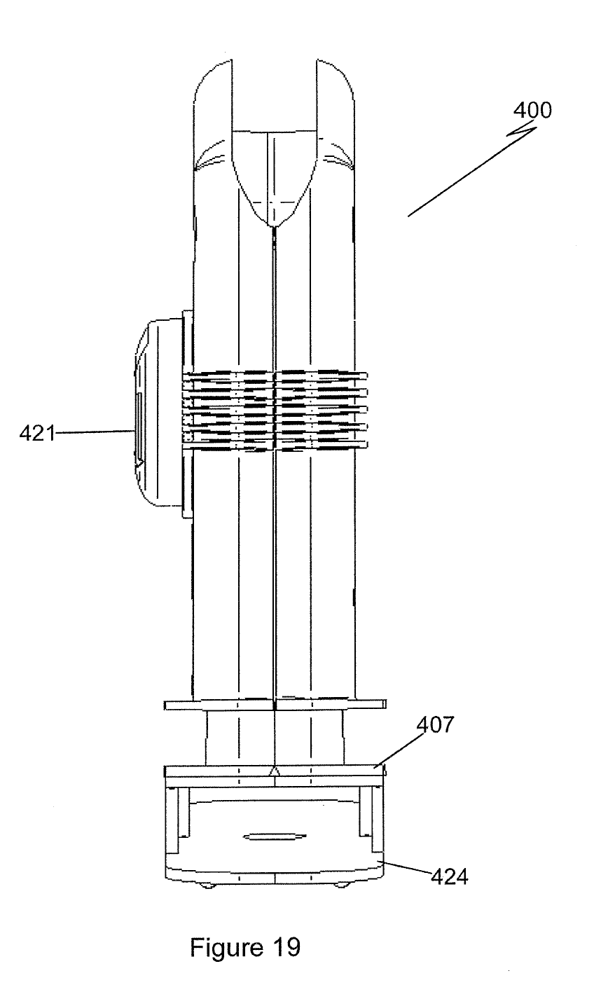

FIG. 19 is a side view of the device of FIG. 17;

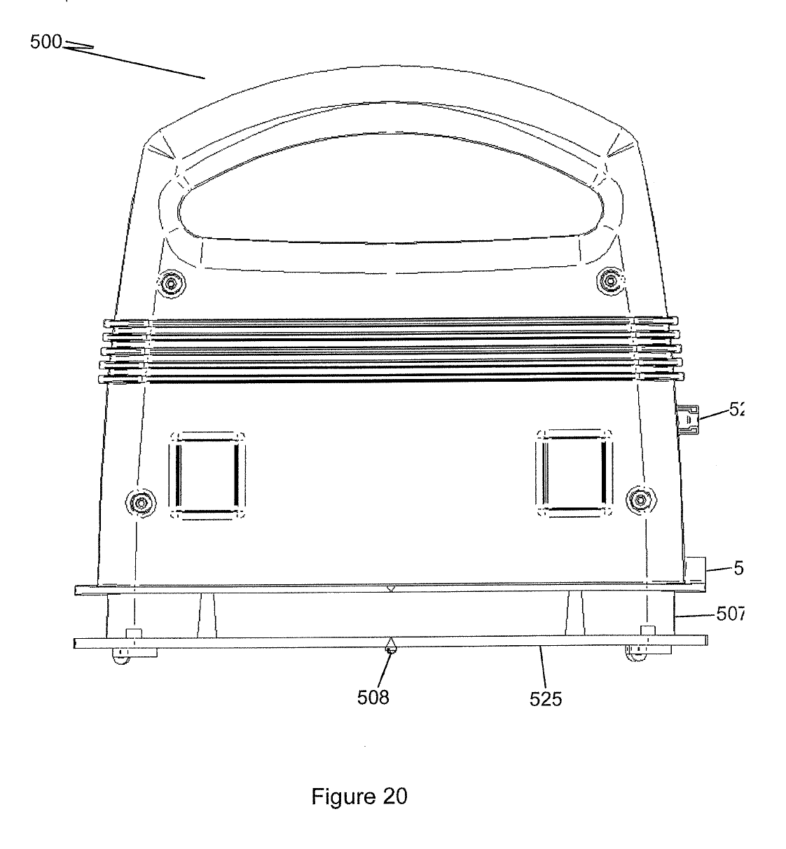

FIG. 20 is a front view of a device with folding feet;

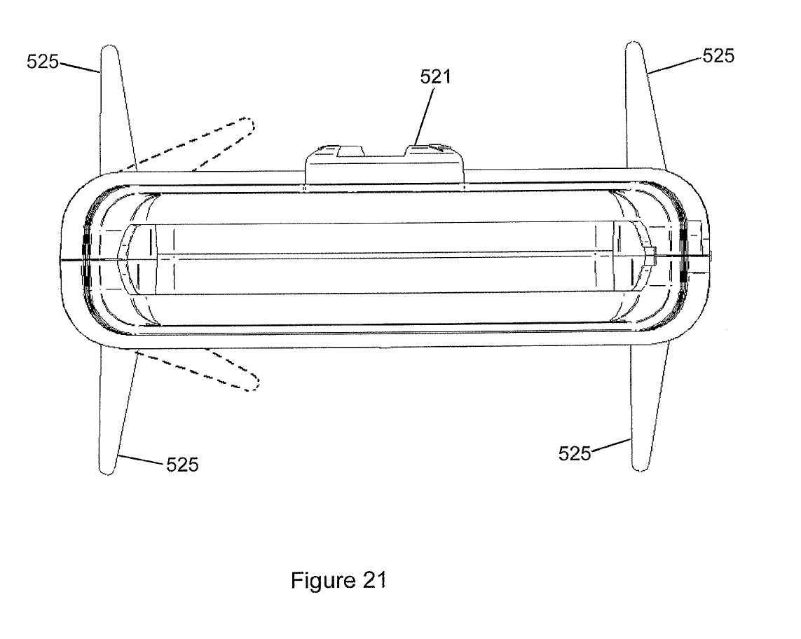

FIG. 21 is a plan view of the device of FIG. 20;

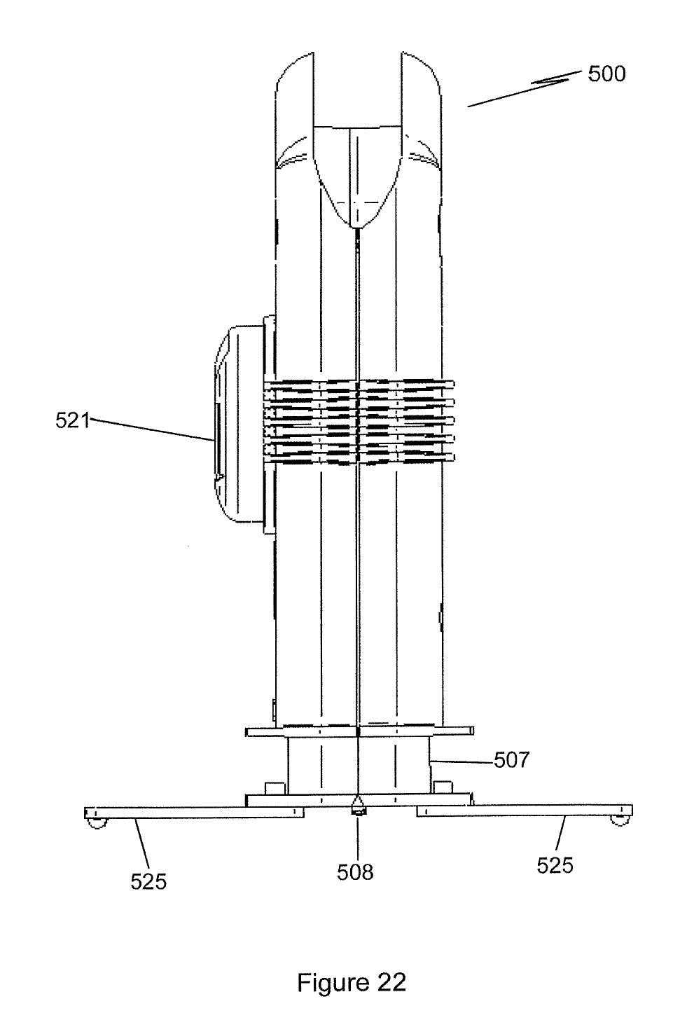

FIG. 22 is a side view of the device of FIG. 20;

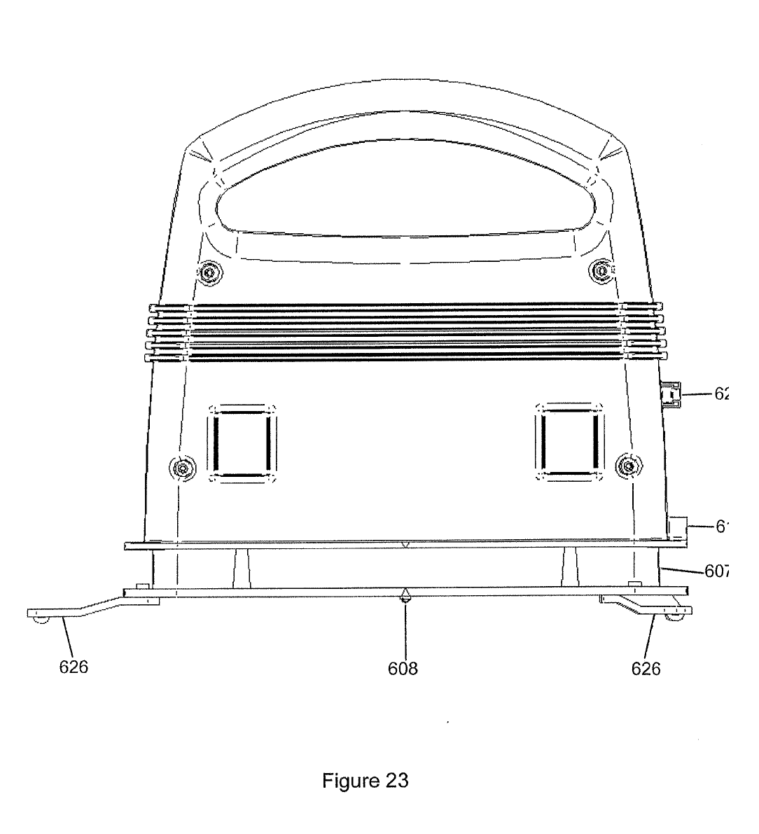

FIG. 23 is a front view of a device with three stepped feet;

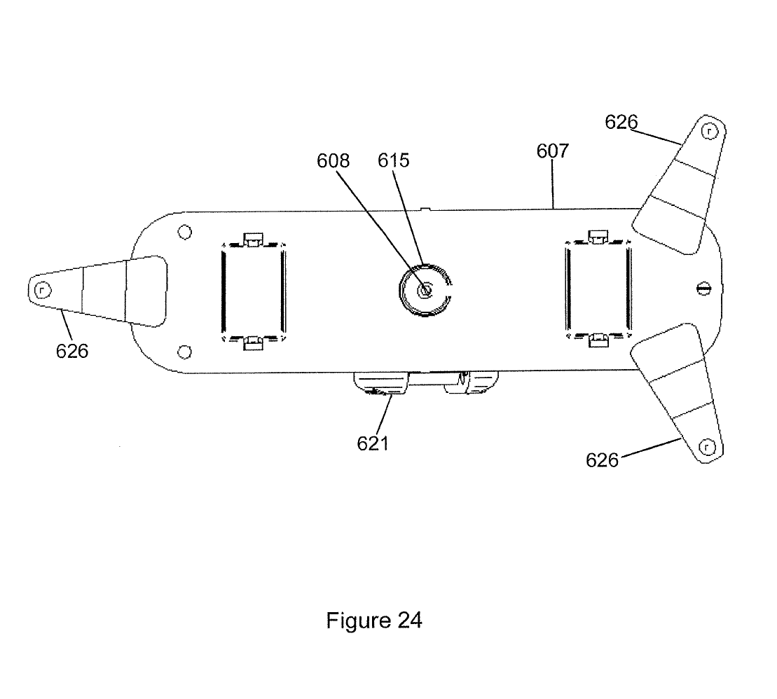

FIG. 24 a view from below of the device of FIG. 23;

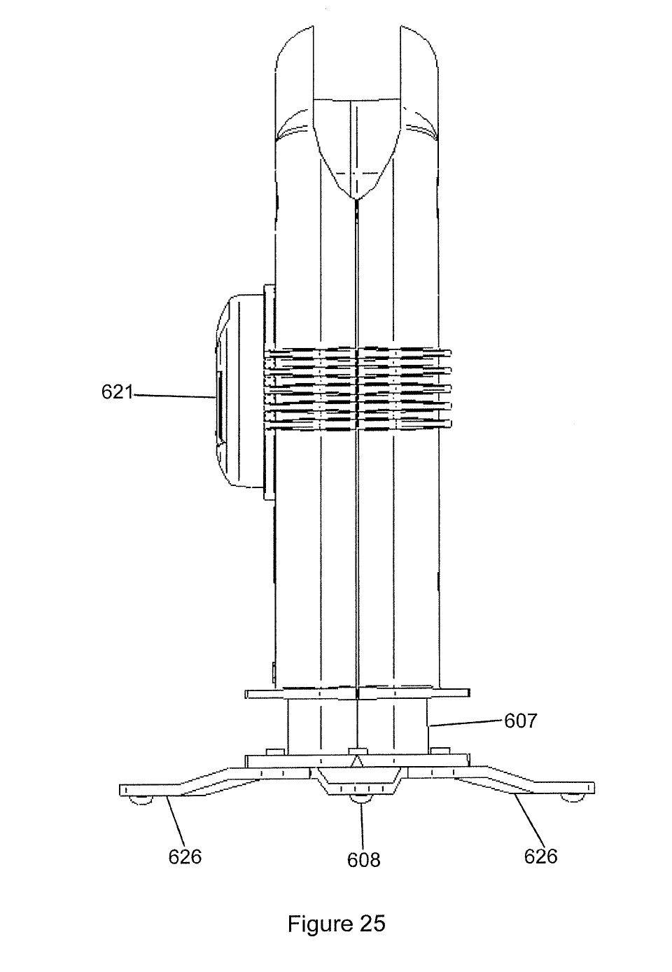

FIG. 25 is a side view of the device of FIG. 23;

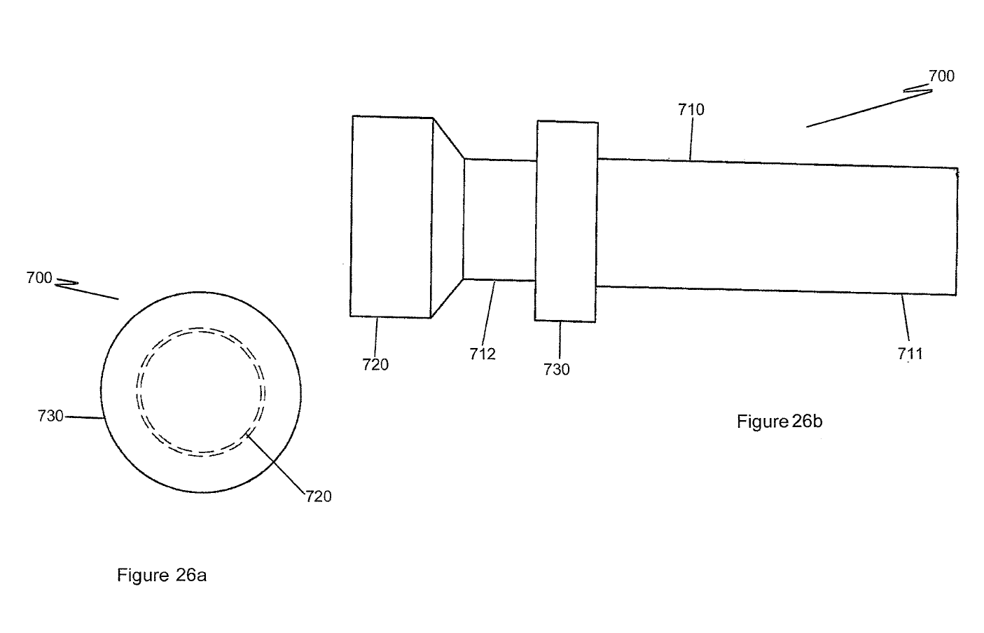

FIG. 26A is a side view of a tack according to the invention;

FIG. 26B is a plan view of a tack according to the invention;

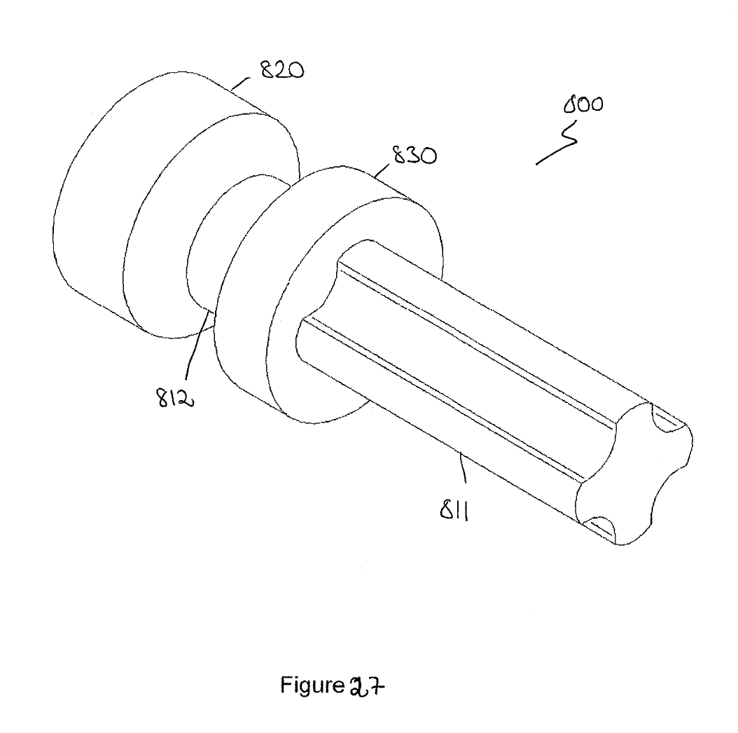

FIG. 27 is a perspective view of an alternative preferred tack according to the invention;

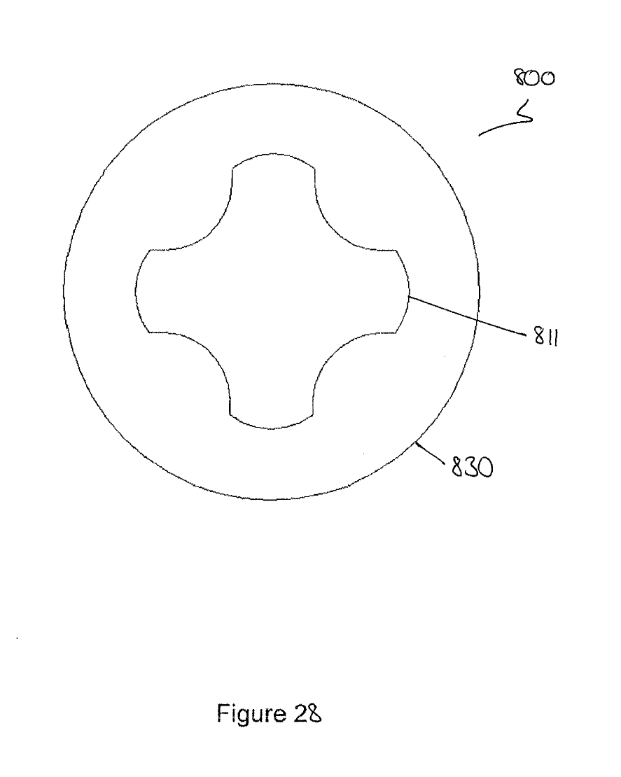

FIG. 28 is a plan view from below of the tack shown in FIG. 27; and

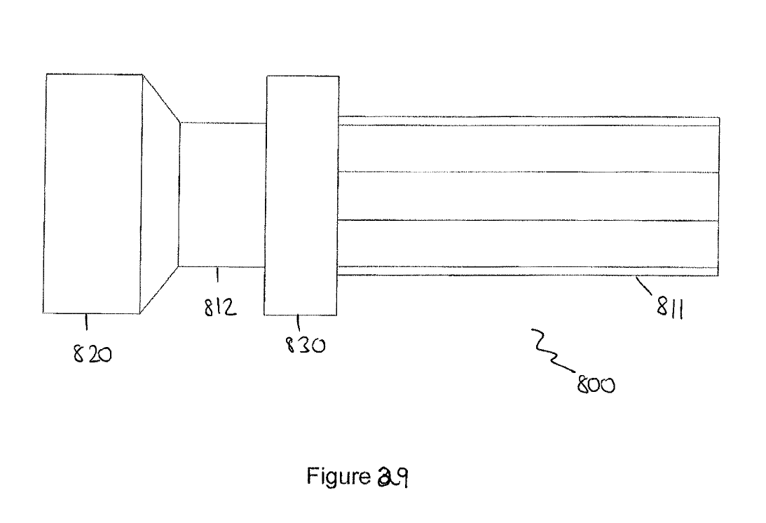

FIG. 29 is a side view of the tack shown in FIG. 27.

Referring to the drawings and initially to FIGS. 1 to 9 there is shown a device 100 for facilitating the insertion of a tack into a surface, the device comprising a housing 2 with a base receiving portion 12 at one end and a handle H at the other end, the housing having a left hand side 2a and a right hand side 2b; a detachable hole-forming rod member 8; a hole forming gear mechanism comprising drive gear 11, drive spindle 9 and a clip or washer 10; and an elongate base 7 movably secured to the housing 2 and adapted to retract into the base receiving portion 12 as the hole forming rod member 8 penetrates the surface and forms the hole.

The footprint of the base 7 is substantially oblong. That is, the part of the base 7 that is placed against the surface in which the hole is to be formed is oblong in shape and has curved edges.

The base 7 is movably secured to the device and adapted to retract and compress into the housing 2 by means of springs 6 on posts 13. The posts 13 are of substantially oval cross section, the upper portion of the post having a smaller cross section than the lower part. The springs 6 are located on the upper part of the posts 13, i.e. on the shoulder provided by the lower part of the post. Guide sleeves 16 within the housing 2 accept the posts 13.

The hole forming rod member 8 and hole forming gear mechanism are located generally in or towards the centre of the device and centrally with regard to the guide sleeves 16 and posts 13 such that the guide sleeves 16 and posts 13 are located evenly and symmetrically either side of the hole forming rod member 8 and hole forming gear mechanism. In other words, the hole forming rod member 8 is located in between the two guide sleeves 16 such that the guide sleeves 16 are each equally distanced from the hole forming rod member 8. This ensures that in use the hole forming rod member 8 rotates as smoothly as possible and ensures the hole forming rod member 8 and base 7 can be operated stably.

Stopping means 18 are provided within the housing 2 above the guide sleeves 16, preventing the springs 6 from moving out of place. The elongate base 7 further comprises a locating hole 15 through which the hole forming rod member 8 protrudes when the device 100 is in use. The locating hole 15 is at the centre of the elongate base 7 and the posts 13 are located at equal distances from the locating hole 15, either side of the locating hole 15.

As can be seen from FIG. 1, the inside of the housing is moulded to accommodate the components of the device.

The elongate base 7 not only has up and down movement with respect to the housing 2 due to the springs 6 but it also has lateral and pivotal movement with respect to the housing 2 due to the shape of the posts 13 and guide sleeves 16.

Device 100 further comprises a winding handle 21 for turning the hole forming rod member 8 against a surface to penetrate the surface. Winding handle 21 comprises handle body 3, handle arm 5 and handle grip attachment 4 for engagement with the handle arm 5 to assist a user in gripping the winding handle 21.

FIG. 3 shows the gearing mechanism of device 100. Bevel gears with tooth-bearing faces (one face on drive gear 11 and one face on drive spindle 9) are used to change the direction of rotation from the vertical rotation of winding handle 21 to the horizontal rotation of the hole forming rod member 8.

Furthermore, device 100 comprises pivotable storage section 1 in which tacks may be stored and storage section 17 in which spare hole forming rod members may be stored. Pivotable storage section 1 is part of handle H and has a pivot point at one end and an indent at the other end. Pivotable storage section 1 is opened by pushing the indented end and lifting the storage section 1 up so that it is only attached to the device by its pivot point.

The hole forming rod member 8 is detachable and can be replaced when worn out. This is done by compressing the base so that it retracts into the base receiving portion revealing the hole forming rod member 8 which then protrudes through locating hole 15 in base 7 and pulling out the hole forming rod member 8 with pliers or the like. The device 100 further comprises a socket (not visible) for hole forming rod member 8.

The device further comprises a protruding tack inserter 19 and protruding tack remover 20. Referring to FIG. 4, the tack inserter 19 is an annular protrusion, half of which protrudes from left hand side of the housing 2a and the other half of which protrudes from right hand side of the housing 2b. The tack inserter 19 is shaped so as to fit over the head of a tack. The tack remover 20 is located above the tack remover on the left hand side of the housing 2b and is U-shaped. The tack remover 20 is shaped so as to accept the head and collar of a tack.

The method for inserting a tack into a wall surface will now be described based on the drawings and referring especially to FIGS. 1 to 9:
a) A hole forming rod member 8 is pushed through locating hole 15 of device 100 and pushed up until it clicks into a locking slot of drive spindle 9 to fix the hole forming rod member 8 in place.
b) The device 100 is then placed against a wall surface.
c) The winding handle 21 is then rotated, e.g. clockwise or counter clockwise, causing the hole forming gear mechanism to turn the hole forming rod member 8 against the wall surface which breaks the wall surface.
d) As the hole forming rod member 8 penetrates the wall surface on further turning of the handle 21, the base 7 depresses against springs 6 and retracts inside base receiving portion 12 of housing 2. The guide sleeves 16 and posts 13 either side of locating hole 15 in base 7 keep the device 100 positioned in a perpendicular axis.
e) The winding handle 21 is rotated until the base 7 is compressed against the bottom of the housing 2, i.e. until the flange of elongate base 7 abuts the flange of housing 2. This indicates that the hole forming rod member 8 has travelled the depth of the base 7, e.g. 12 mm, to complete the depth of hole required.
f) A tack 700 or 800 is then fully inserted into the hole in the wall surface, preferably using the protruding tack inserter 19.

Referring to FIGS. 10-15 there is shown an alternative embodiment of the device, indicated generally by the reference numeral 200. Like features of device 200 are indicated by like reference numerals indicated above for device 100. Device 200 comprises a housing 202 with a base receiving portion 212 at one end, a hole forming rod member 208; a base 207 movably secured to the housing 202 and adapted to retract and compress into the base receiving portion 212 as the hole forming rod member 208 penetrates the surface and forms the hole; and a hole forming gear mechanism comprising drive gear 211, spindle 209 and a clip or washer (not visible). The device 200 further comprises a winding handle 221 for turning the hole forming rod member 208 against the surface to penetrate the surface.

Springs 206 by which the base 207 compresses against the housing 202 of device 200 are shown in FIG. 13. Posts 213 and guide sleeves 216 showing how the base 207 may be attached to device 200 are also shown in FIG. 13. The posts 213 are substantially cylindrical in shape and guide sleeves 216 have a correspondingly cylindrical receiving portion.

The base 207 further comprises a locating hole 215 through which the hole forming rod member 8 protrudes when the device 200 is in use.

Device 200 as shown in FIGS. 10 to 15 is attached to the side or base of a known device D which may be used to insert a tack into the hole formed by device 200.

FIG. 12 shows the gearing mechanism of device 200. Bevel gears with two conically shaped tooth-bearing faces (one face on drive gear 211 and one face on drive spindle 209) are used to change the direction of rotation from the vertical rotation of winding handle 221 to the horizontal rotation of the hole forming rod member 208.

FIGS. 10 and 14 show a retaining slot 222 by which the known device D may be secured to device 200.

Referring to FIG. 16 there is shown another alternative embodiment of the device according to the invention, indicated generally by the reference numeral 300. Like features of device 300 are indicated by like reference numerals indicated above for device 100. Device 300 further comprises screws 323 which are used to attach the components of device 300 together. The base 307 of device 300 further comprises detachable dust collector cap 322. A dust collector surrounds locating hole 315 and the detachable cap 322 fits into the dust collector, the dust collector cap 322 having a hole in the middle from which the hole forming rod member 308 protrudes in use.

Referring to FIGS. 17-19 there is shown another alternative embodiment of the device according to the invention, indicated generally by the reference numeral 400. Like features of device 400 are indicated by like reference numerals indicated above for device 100. Device 400 further comprises an angled base 424. This angled base is pivotable with respect to the device 400 and is particularly suitable for forming holes which are not perpendicular to the surface in which they are formed.

Referring to FIGS. 20-22 there is shown an alternative embodiment of the device, indicated generally by the reference numeral 500. Like features of device 500 are indicated by like reference numerals indicated above for device 100. The base 507 of device 500 further comprises two sets of folding feet 525. These elongate pivotable feet 525 are movable in a plane parallel to the base. When the feet are in a position in which they are substantially perpendicular or otherwise angled with respect to the base, they provide device 500 with extra stability.

Referring to FIGS. 23-25 there is shown an alternative embodiment of the device, indicated generally by the reference numeral 600. Like features of device 600 are indicated by like reference numerals indicated above for device 100. The base 607 of device 600 further comprises three stepped feet 626, each of which has a spherical protrusion. These stepped feet 626 provide stability of the device 600 on uneven surfaces.

FIGS. 26A and 26B show a tack 700 suitable for insertion into a hole in a surface formed by any one of devices 100, 200, 300, 400, 500 or 600. An object may be hung from an inserted tack 700. The tack 700 comprises a cylindrical elongate body 710, a head 720 and collar 730, the body 710 having a wider elongate section 711 and a narrower elongate section 712. The head 720 is at the end of the narrower section 712 and the collar 730 is mounted intermediate portions 711 and 712. The head and collar have a diameter wider than the diameter of the body 710.

FIGS. 27 to 29 show a preferred tack 800 suitable for insertion into a hole in a surface formed by any one of devices 100, 200, 300, 400, 500 or 600. An object may be hung from an inserted tack 800. The tack 800 comprises an elongate body, a head 820 and collar 830, the body having a cylindrical section 811 and a cruciform shaped section 812, i.e. an elongate section provided with ribs. These ribs distort to the shape of the hole in the surface formed by any one of devices 100, 200, 300, 400, 500 or 600. The head 820 is at the end of section 812 and the collar 830 is mounted intermediate portions 811 and 812. The head and collar have a diameter wider than the diameter of the body 810.

It will of course be understood that the invention is not limited to the specific details as herein described, which are given by way of example only, and that various alterations and modifications are possible without departing from the scope of the invention as defined in the appended claims.

1. A device for forming a hole in a surface for subsequent insertion of a tack into the hole, the device comprising:
a housing having a base receiving portion;
means for holding a detachable hole forming rod member;
means for turning the hole forming rod member;
means for urging the hole forming rod member out of the housing to form a hole in the surface, wherein the hole is formed substantially perpendicular to the surface; and
a base moveable within the housing and adapted to be retractable into the base receiving portion as the hole forming rod member is urged forwardly to form the hole in the surface.

2. The device for forming a hole in a surface as claimed in claim 1, further comprising a post, a guide sleeve adapted to receive the post and resilient means to facilitate the retraction of the base from a fully extended position to a fully retracted position, preferably wherein the resilient means are associated with the post.

3. The device for forming a hole in a surface as claimed in claim 2, wherein the base comprises one of said post and guide sleeve and the base receiving portion comprises the other of said post and guide sleeve.

4. The device for forming a hole in a surface as claimed in claim 2, wherein the post, guide sleeve and resilient means are encased in the housing of the device.

5. The device for forming a hole in a surface as claimed in claim 2, wherein the post or guide sleeve is upstanding from the base.

6. The device for forming a hole in a surface as claimed in claim 2, wherein said device comprises at least two posts and at least two guide sleeves, wherein each guide sleeve is adapted to receive one post.

7. The device for forming a hole in a surface as claimed in claim 6, wherein at least one guide sleeve and at least one post are located towards one end of the device and at least one guide sleeve and at least one post are located towards an opposing end of the device.

8. The device for forming a hole in a surface as claimed in claim 6, wherein the means for holding the hole forming rod member is located in between the at least two guide sleeves such that the guide sleeves are each equally distanced from the means for holding the hole forming rod member.

9. The device for forming a hole in a surface as claimed in claim 2, wherein the post comprises a shoulder on which the resilient means rests.

10. The device for forming a hole in a surface as claimed in claim 1, wherein the means for holding a hole forming rod member and the means for urging the hole forming rod member out of the housing co-operate to hold the hole forming rod member in a substantially perpendicular orientation relative to the transverse plane of the base receiving portion of the housing.

11. The device for forming a hole in a surface as claimed in claim 1 wherein the footprint of the base is substantially oblong.

12. The device for forming a hole in a surface as claimed in claim 1, wherein the base is configured to be moveable laterally with respect to the housing of the device.

13. The device for forming a hole in a surface as claimed in claim 1, wherein the means for holding a hole forming rod member is located generally in or towards the centre of the device.

14. The device for forming a hole in a surface as claimed in claim 1, wherein the device is a manual device configured to be operated solely by hand.

15. The device for forming a hole in a surface as claimed in claim 1, wherein the base comprises a substantially perpendicular stabilizing member, optionally wherein the stabilizing member is detachable.

16. The device for forming a hole in a surface as claimed in claim 1, wherein the base is adapted to pivot with respect to the housing.

17. The device for forming a hole in a surface as claimed in claim 1, wherein the device is motorized and battery operated.

18. The device for forming a hole in a surface as claimed in claim 1, wherein the angle of the base with respect to the housing is set by the user.

19. The device for forming a hole in a surface as claimed in claim 1, wherein in use the base contacts the surface in which the hole is to be formed at three or more fixed points.

20. The device for forming a hole in a surface as claimed in claim 1, wherein the device further comprises one or more levelling and/or measurement devices.

21. A device for forming a hole in a surface as claimed in claim 1, wherein the device further comprises a counter with means for stopping the rotation of the hole forming rod member after a predetermined number of turns.

22. A device for forming a hole in a surface as claimed in claim 1, wherein the device is adapted to ensure that the hole forming rod member protrudes from the device on compression of base.

23. A device for forming a hole in a surface as claimed in claim 1 for inserting a tack into the surface, the device further comprising means for inserting a tack into the hole in the surface, wherein said means for inserting a tack comprises a protruding member which fits over at least a portion of the head of the tack or a plunger and resilient means.

24. A tack suitable for insertion into hole a surface formed by the device as defined in claim 1, the tack comprising an elongate body, a head and collar, wherein the body comprises a wider elongate section and a narrower elongate section, wherein the wider elongate section is provided with ribs which distort to the shape of the hole in the surface, wherein the head is at the end of the narrower section and the collar is mounted intermediate the sections, wherein the head and collar have a diameter wider than the diameter of the body and wherein an object may be hung from the inserted tack.

25. A method for facilitating the insertion of a tack into a surface using the device for forming a hole in a surface as defined in claim 1, preferably wherein the tack comprises an elongate body, a head and collar, wherein the body comprises a wider elongate section and a narrower elongate section, wherein the wider elongate section is provided with ribs which distort to the shape of the hole in the surface, wherein the head is at the end of the narrower section and the collar is mounted intermediate the sections, wherein the head and collar have a diameter wider than the diameter of the body and wherein an object may be hung from the inserted tack.

26. A method as claimed in claim 25, comprising the following steps:
a) placing the device against the surface in which the hole is to be formed;
b) rotating the means for turning the hole forming rod member causing the hole forming rod member to penetrate the surface; and
c) further rotating the means for turning the hole forming rod member until the base is retracted and compressed into the base receiving end portion of the device.

27. (canceled)

28. (canceled)

29. (canceled)

30. The device for forming a hole in a surface as claimed in claim 1 wherein the device is battery operated.

31. A manual device for forming a hole in a surface for subsequent insertion of a tack into the hole, the device comprising:
a housing having a base receiving portion;
means for holding a detachable hole forming rod member;
means for turning the hole forming rod member;
means for urging the hole forming rod member out of the housing to form a hole in the surface, wherein the hole is formed substantially perpendicular to the surface; and
a base moveable within the housing and adapted to be retractable into the base receiving portion as the hole forming rod member is urged forwardly to form the hole in the surface,
wherein the base is provided with a locating hole through which the hole forming rod member protrudes on retraction of the base,
wherein the base is secured to the device by two posts and two respective guide sleeves,
wherein each post is moveably located in a respective guide sleeve either side of the locating hole; and
wherein the housing is provided with a handle configured such that, in use, a user's hand is directly above the hole forming rod member.
